(19) United States
(12) Patent Application Publication
(10) Pub. No.: US 2020/0401462 A1
(43) Pub. Date: Dec. 24, 2020

(54) SOFTWARE COLLABORATION PLATFORM FOR ADVANCED WORKFLOWS AND DIGITAL TWINS

(71) Applicant: Calgary Scientific Inc, Calgary (CA)

(72) Inventors: Kevin Viggers, Calgary (CA); Dan Pigat, Calgary (CA)

(21) Appl. No.: 16/906,413

(22) Filed: Jun. 19, 2020

Related U.S. Application Data
(60) Provisional application No. 62/863,613, filed on Jun. 19, 2019.

(51) Int. Cl. G06F 9/52; G06F 9/54

(52) U.S. Cl. CPC G06F 9/52; G06F 9/546

(57) ABSTRACT

Methods and systems for providing a collaboration platform that enables “software agents” to share data with one another such that one software agent may interoperate with the other software agent. When the domains of different software agents overlap, completely, or partially, it becomes possible for the software agents to exchange information and behaviors in collaboration using a shared model and to create digital twins. Collaboration among the software agents, connected client(s), devices and other services may be provided through a data synchronization service and shared model provided by, and used within, the collaboration platform.

### CROSS-REFERENCE TO RELATED APPLICATION

This application claims priority to U.S. Provisional Patent Application No. 62/863,613, filed Jun. 19, 2019, entitled “SYSTEM AND METHOD FOR SOFTWARE APPLICATION INTEROPERABILITY AND COLLABORATION,” which is incorporated herein by reference in its entirety.

### BACKGROUND

It is common for users of software, such as GIS mapping software, CAD software, seismic software, etc., to rely on a variety of applications as part of their workflow. Currently, these applications have a limited ability to share their full data or communicate dynamically. These limitations make it difficult to bring disparate/heterogeneous applications together in a meaningful way.

### SUMMARY

Disclosed herein are systems and methods for providing a collaboration platform or framework that enables “software agents” to share data with one another in a software agent environment while providing a full dynamic experience of using multiple applications simultaneously with access to their full respective datasets. When the domains of different software agents overlap, completely, or partially, it becomes possible for the software agents to exchange information and behaviors in collaboration using a shared model. Collaboration among the software agents (e.g., connected devices and other services) may be provided through one or more of a presence service, a messaging service, a data synchronization service and the shared model provided by, and used within, the collaboration platform.

In accordance with an aspect of the present disclosure, a collaboration platform for providing a shared software agent environment between at least two heterogenous software agents is disclosed. The collaboration platform includes a data synchronization service into which a first software agent publishes properties and behaviors into a shared model. The data synchronization service advertises the shared model such that at least one second software agent subscribes to properties and behaviors that are of interest to the least one second software agent. The first software agent and/or the at least one second software agent utilize a communication link between each of the first software agent and the at least one second software agent to observe, consume and/or contribute to the shared model. Updated data from the shared model is synchronized between the first software agent and the at least one the second software agent in the shared software agent environment.

In accordance with another aspect of the present disclosure, a framework for creating a shared agent environment between at least two heterogenous software agents is described. A collaboration platform includes a data synchronization service that provides a mechanism wherein the software agents publish and subscribe to messages. The software agents advertise a shared model that is used to exchange information and behaviors in collaboration between the software agents in the shared agent environment. The collaboration platform receives a connection from a first software agent and at least one second software agent, and the first software agent publishes a representation of the data and behaviors into the shared model for consumption and thereafter advertises the shared model using the data synchronization service. At least one second software agent subscribes to the shared model and the first software agent and/or the at least one second software agent use a communication link between each of the first software agent and the at least one second software agent and use the data synchronization service to observe, consume and/or contribute to the shared model. As a result, a view may be presented that is associated with the first software agent and/or the at least one second software agent and the shared model. A related method is also described herein.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example environment having software agents and a collaboration platform;

FIGS. 2A-2D illustrate additional details of the collaboration platform of FIG. 1;

FIG. 3 illustrates additional details of the shared model as it relates to the software agents;

FIG. 4 illustrates the example environment of FIG. 1 with a connected collaborating browsers;

FIG. 5 illustrates the example environment of FIG. 1 with a connected machine learning/artificial intelligence service, an Internet of Things (IoT) device and a video device;

FIG. 6 illustrates an example operational flow implemented in the environment of FIGS. 2A-2D;

FIG. 7 illustrates another example operational flow implemented in the environment of FIG. 5;

FIG. 8A illustrates an existing seismic application;

FIG. 8B illustrates an existing GIS mapping application;

FIG. 8C illustrates an output where the GIS information and seismic data collaborate together as software agents;

FIGS. 9A-9C illustrate an example of a CAD application and a gaming engine collaborating as agents;

FIGS. 10A-10C illustrate example user interfaces showing a GIS mapping application, a game application and an IoT device collaborating to present an interactive view of a cityscape;

FIGS. 11A-11B illustrate several game agents in combination with other agents to create digital twins;

FIG. 12 is an example user interface showing an artificial intelligence service collaborating with a medical imaging application to present an interactive view of medical diagnostic imagery; and

FIG. 13 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for a collaborative platform to provide a shared software agent environment, it will become evident to those skilled in the art that the implementations are not limited thereto.

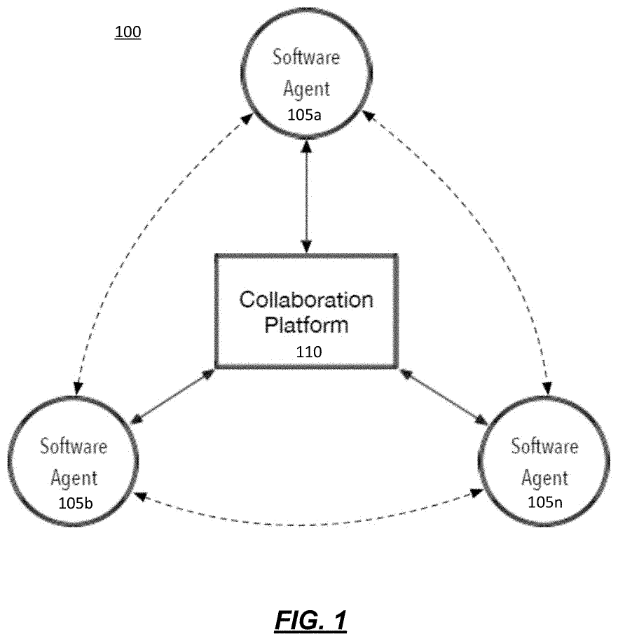

The present invention is generally directed to a collaboration platform that enables “software agents” to share data with one another such that one software agent may interoperate with the other software agent. With reference to FIG. 1, there is illustrated an example environment 100 that includes one or more software agents 105a, 105b, 105n, and a collaboration platform 110. The software agents 105a, 105b, 105n may include user-driven software, as well as autonomous software and services. In FIG. 1 and throughout the various views, solid lines represent communication links between the software agents 105a, 105b, 105n and the collaboration platform 110, whereas the dashed lines represent peer-to-peer communication links between the software agents 105a, 105b, 105n.

The software agents 105a, 105b, 105n may be dynamically combined to form one or more digital twins (i.e., a software representation of multiple systems that can bidirectionally send and receive data in real-time). In particular, the combination of the software agents 105a, 105b, 105n brings together different aspects of a physical environment such that the combination of software agents 105a, 105b, 105n can be used to create a digital twin. The software agents 105a, 105b, 105n may be operating on behalf of an authenticated identity or remain anonymous. The software agents 105a, 105b, 105n may be heterogenous (i.e., represent dissimilar applications, devices, vendors, developers, etc. with respect to their execution context) and operate in many contexts, such as, but not limited to, running as browser applications, desktop applications, hosted services, embedded systems, mobile apps and more.

Similarly, the software agents 105a, 105b, 105n need not be applicable to only visual workflows but can include data streaming and consuming agents, conversational bots, AL/ML, batch processing agents, etc. For example, the browser may communicate with a streaming game as one of software agents 105a, 105b, 105n. An example of this is described below. Similarly, the software agents 105a, 105b, 105n may operate to provide a multiplayer environment (i.e., an environment where many software agents consume from a particular producer agent), visual workflows, data streaming service, consuming agents, conversational bots, Artificial Intelligence (AI)/Machine Learning (ML), batch processing, machine vision, etc.

The collaboration platform 110 may facilitate flexible, communicative, real-time collaboration between any number of software agents 105a, 105b, 105n. The collaboration platform 110 allows the software agents 105a, 105b, 105n to discover, coordinate, and collaborate with one another within an “agent environment.” The “agent environment” is a common reference point around which software agents 105a, 105b, 105n can coordinate their activity. Similar to a physical meeting room that may house participants and materials associated with a meeting, the agent environment provided by the collaboration platform 110 provides persistent storage services, real-time data synchronization services, messaging mechanisms, as well as other services, to enable the software agents 105a, 105b, 105n to achieve any number of collaborative scenarios and with bidirectional data flows. The nature of what the software agents 105a, 105b, 105n share with the other software agents within the agent environment is unbound and the software agents can further subdivide spaces into subspaces, allowing them to narrow collaboration to fine-grained contributions within the agent environment.

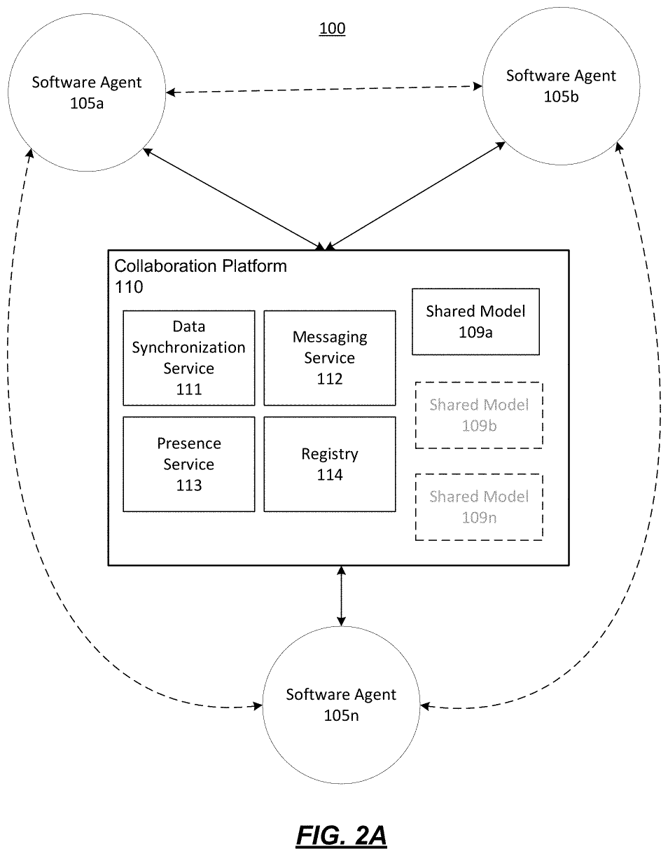

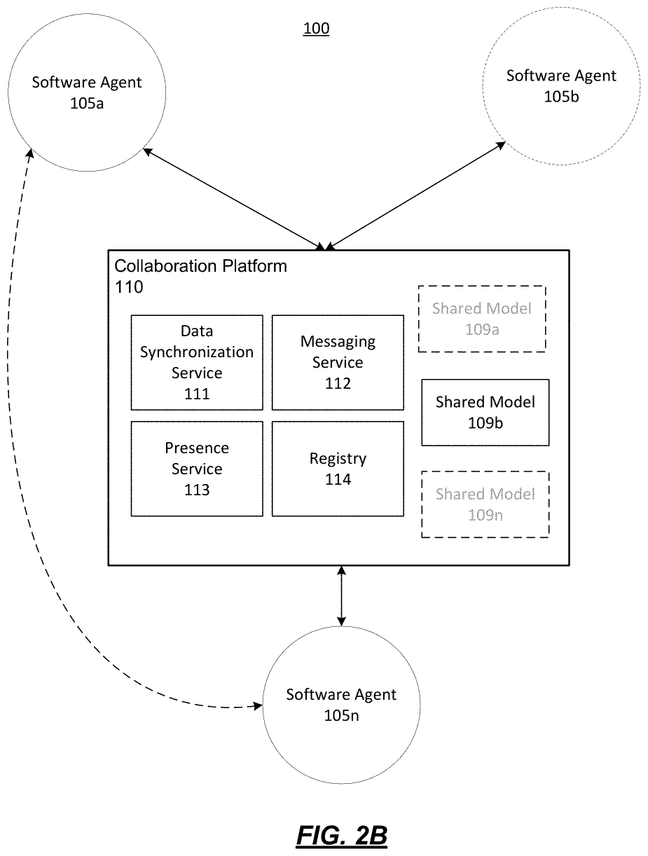

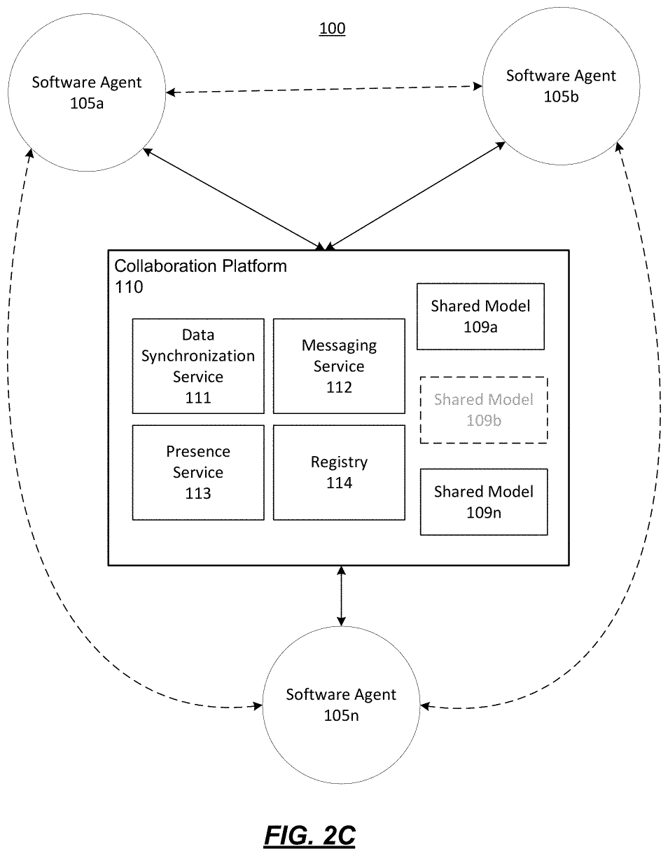

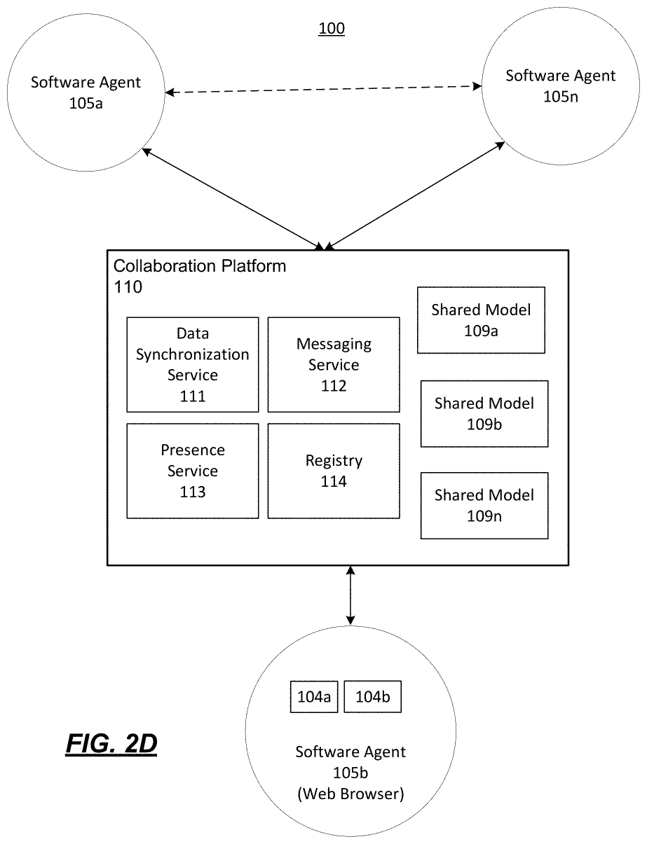

With reference to FIGS. 2A-2D, there is illustrated additional details of the collaboration platform 110 of the example environment 100. As shown, the software agents 105a, 105b, 105n communicate with the collaboration platform 110. As noted above, collaboration platform 110 enables communication between heterogeneous software agents. Once connected to the collaboration platform 110, the software agents 105a, 105b, 105n may use peer-to-peer communication links between them to communicate information such as WebRTC data, audio data, video data, defined protocol communications, and direct messages therebetween. The software agents 105a, 105b, 105n may further establish a network connection with one or more of a data synchronization service 111, a messaging service 112, and a presence service 113 within the collaboration platform 110 using, e.g., WebSockets (in the browser context) or a socket (in other contexts), in order to provide full-duplex communication channels over a single TCP connection. In some implementations, MQTT (Message Queuing Telemetry Transport) may be used, which is an ISO standard publish-subscribe-based messaging protocol. It is noted that the connections are not limited to the above and other types of connections may be used.

The data synchronization service 111 is described in further detail below and offers/advertises a shared model 109a to publishing/subscribing software agents 105a, 105b, 105n. The messaging service 112 provides a mechanism to enable the software agents 105a, 105b, 105n to publish and subscribe to messages. Each of the software agents 105a, 105b, 105n can send and receive messages to/from the messaging service 112, and can choose to disconnect or be force disconnected from the messaging service 112 within the collaboration platform 110.

The presence service 113 enables software agents to discover each other. The presence service 113 sends notifications as the software agents 105a, 105b, 105n arrive and leave a particular agent environment. The arrival and departure notifications are sent to the other software agents in the particular agent environment. The presence service 113 enables discovery of software agents 105a, 105b, 105n, including heterogeneous software agents, as the software agents 105a, 105b, 105n agents may not be aware of each other until they enter the agent environment.

Access to any of the data synchronization service 111, the messaging service 112, and the presence service 113 can be limited using access control mechanisms, such as bearer tokens, etc.

Shared model 109a, 109b, 109n

Software design often seeks to abstract or model aspects of reality or a domain of interest. Software models define the subjective properties and behaviors of the domain, as deemed appropriate for the purpose of the software from the perspective of the creator of the software. Different software may model different aspects of the same domain, or similar aspects of the same domain, differently. For example, one software might consider points on a Cartesian plane as ordered pairs with an (x, y) value. Another software may express the very same concept of points using polar coordinates. Both define a domain of two-dimensional points, but using different models.

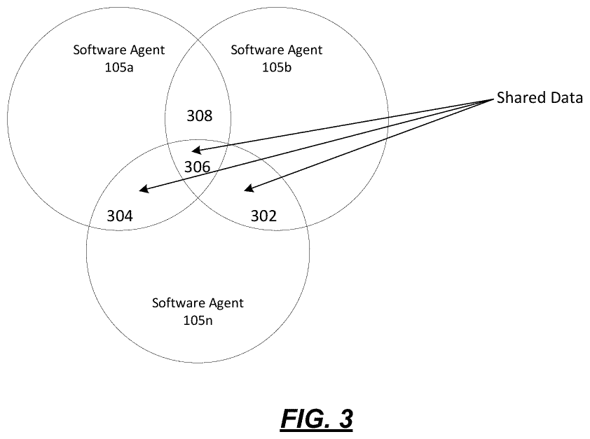

When the domains of different software agents overlap, completely, or partially, it becomes possible for the software agents to exchange information and behaviors in collaboration using one or more shared model 109a, 109b, 109n. There is no limit on the number of shared models that may exist in the environment 100. To accomplish this, the software agents 105a, 105b, 105n may offer/advertise a common representation of their data and behavior as a shared model into the agent environment using the data synchronization service 111 and, optionally a registry 114 that may save the data in a blockchain, database or other storage. This may be performed by translating representations of information. For example, with reference to FIG. 3, there is shown a Venn Diagram showing common properties and behaviors among the software agents 105a, 105b, 105n, which are represented by the areas of overlap among the circles, each representing a possible shared model. Area 302 shows the common properties and behaviors shared between software agents 105b and 105n. Area 304 shows the common properties and behaviors shared between software agents 105a and 105n. Area 306 shows the common properties and behaviors shared between all three software agents 105a, 105b and 105n. The software agents 105a, 105b and 105n would each subscribe to the agreed-upon common properties and behaviors (area 306). In another aspect of the present disclosure, a particular software agent may share first of properties and behaviors with one software agent and a different set of properties and behaviors with another software agent. For example, software agent 105a may share properties and behaviors associated with area 304 with software agent 105n and share properties and behaviors associated with area 308 with software agent 105b. In yet another feature, one agent can direct message another agent such that the two agents can communicate privately over a peer-to-peer link.

Referring again to FIG. 2A, the software agent 105a may use the data synchronization service 111 to advertise the shared model 109a as the common language, i.e., abstraction, that all three software agents 105a, 105b, 105n understand. Using the shared model 109a, the software agents 105a, 105b, 105n can fully or partially represent the information modelled by the agents. Alternatively or additionally, the shared model 109b may be retrieved from the registry 114 and used by the software agents 105a, 105b, 105n to represent information. Yet further, the shared model 109c may have been advertised by a software agent that has left the agent environment, but allowed the shared model 109c to persist for use by the software agents 105a, 105b, 105n.

In FIG. 2A, the software agents 105a, 105b, 105n have agreed to use the shared model 109a and may publish (i.e., advertise) any contributions they wish to make into the data synchronization service 111 (e.g., as the shared model 109a) by submitting an entry into that service 111. Data may be written to the shared model 109a as key/value pairs. Each software agent knows which keys are of interest and will subscribe by registering an interest in those keys. These entries may also contain a unique id as well as a type field, which indicates the nature of the data of the contribution, and additionally, the data of the contribution itself. Other agents in the same agent environment are notified of changes in the entries in the shared model 109a, and based on the type of the entry, the other software agents may choose whether or not they recognize the type field, and if they want to read or contribute to the data of that entry. The value in the type field of an entry can be thought of as the language (protocol, schema) of the contribution, and if another agent recognized the type value, then it knows something about the semantics and syntax of the shared data associated with that entry.

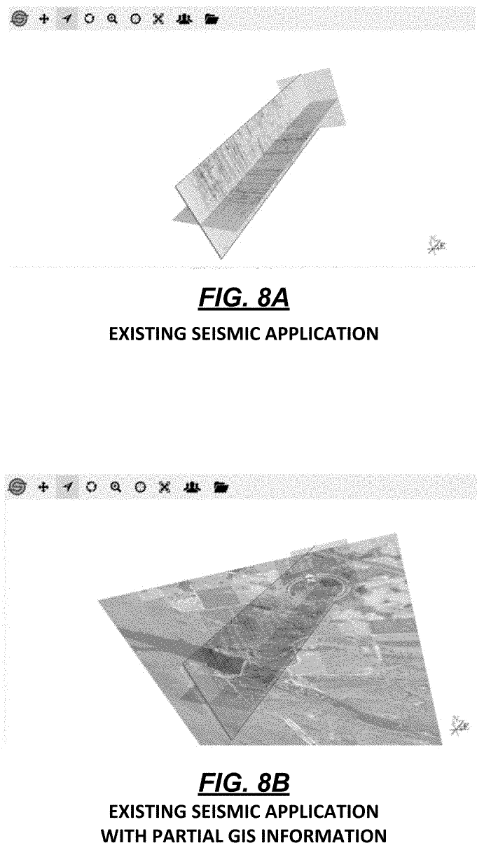

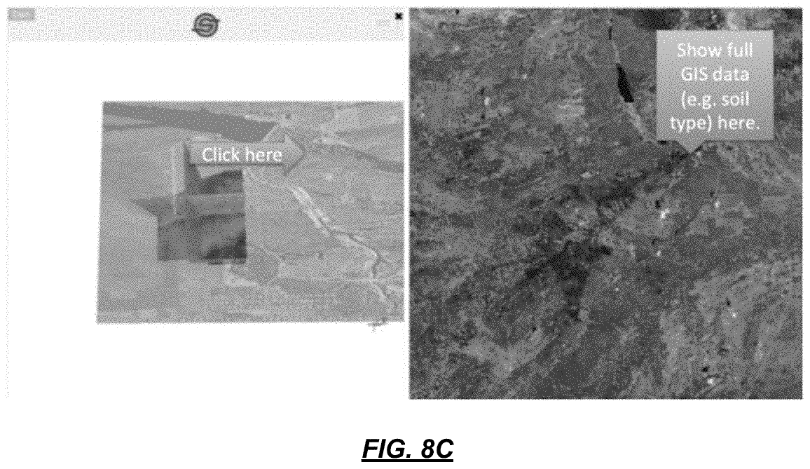

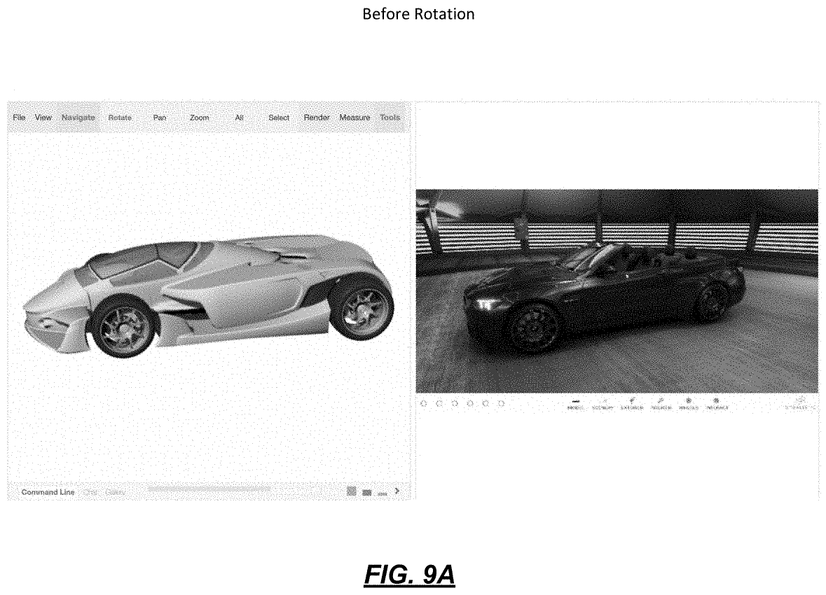

In a collaborative mapping example (see, FIG. 8C, below), one agent (e.g., software agent 105a) establishes the shared model 109a around the viewport of a map. The type of this shared model is ‘viewport’. Other agents (e.g., software agents 105b, 105n) in the agent environment that recognize this type ‘viewport’ may choose to follow it, and adjust their own local map viewport with the latitude, longitude, zoon, pitch, bearing values in the shared model. An example is below:

```
  ″id″:″e3d2ee7c-827f-4d6f-934e-b46ae56333ee″
  ″type″: ″viewport″,
  ″value″:
″{\″latitude\″:51.042197619477946,\″longitude\″:-
302.05270554569495,\″zoom\″:14.830446930292599,\″pitch
\″:60,\″bearing\″:173.6618344720914,\″agentId\″:\″b765
5069-a22c-4492-aeac-7cae51c3edf1\″}
```

Similarly, if other agents want to alter the shared model, they may do so, in this case, updating one or more attributes of the viewport model. In collaborative mapping example, the viewport entry is assumed to be the only one in the agent environments shared models, but generally speaking, every contribution has a unique id, allowing multiple entries of the same type to be referenced and tried independently.

It is possible for an agent to see a type that it believes it understands, but after inspecting the data, finds that it is not recognizable as a viewport as it understands ‘viewports’. A solution to this would be to use a more universal approach, such as a Uniform Resource Name (URN) scheme for model types, for example, urn:mpeg:mpeg7:schema:2001.

The software agents 105a, 105b, 105n can register their interest in, and receive notifications of additions and changes to that data in the shared model 109a, 109b, 109n using the data synchronization service 111. Software agents 105a, 105b, 105n can use the shared model 109a, 109b, 109n to collaborate directly, in the sense that one agent might publish an explicit value or data set into the agent environment, for other agents to receive. A software agent 105a, 105b, 105n can collaborate indirectly, by contributing information that references a value or data set by offering information on how to obtain or access that value or data set, such as a URL to a website containing the value or data set.

The collaboration platform 110 may also provide for bookmarking of a state of agent environment and an audit trail of the interactions of the software agents 105a, 105b, 105n using information from the shared model 109a using the registry 114. It may be desirable to capture the various views of different software agents 105a, 105b, 105n at a point in time to recreate a previous state as a bookmark, or to verify transactions. In one aspect, the state of each of the software agents 105a, 105b, 105n may be saved to a single datastore, such as a database or in a blockchain. This saved information may be used to launch the software agents 105a, 105b, 105n in the agent environment at that saved point in time. By capturing information about each of the software agents 105a, 105b, 105n from shared model 109a along with human readable form (e.g., a thumbnail image, time/date stamp), the software agents 105a, 105b, 105n can be launched to their previous state and kept in context with each other. This mechanism provides for asynchronous sharing (e.g., “go see what we talked about”), continuity (e.g. “let's pick up where we left off”), and creating a transactional record (i.e. to verify a smart contract in a blockchain).

As an example, when designing a building, a map of the area may be presented alongside a visualization (a Building Information Modeling (BIM), computer aided design (CAD) or game model) together with adjustments or notes. Each of these aspects would be represented by one of the software agents 105a, 105b, 105n and their respective service. The state of the shared model 109a associated with the software agents 105a, 105b, 105n may be saved at a point in time that can be verified at a later date by launching the software agents 105a, 105b, 105n (and their respective services) to the “bookmarked” (i.e., saved) discussion and notes.

In accordance with the present disclosure, the dynamic nature of the shared model 109a allows software agents to come and go from a particular software agent environment. For example, in the case of a digital twin, this means more systems (e.g. GIS, IoT) can join and contribute to the shared model 109a for an updated and more holistic view of a digital twin. The independence of systems allows the flexibility of each to be deployed and updated without affecting the others. Software agents (e.g. browsers, video streams) can also join and leave, creating flexible collaboration of users within these dynamic systems. In an example, in training and simulation situations, it will be useful for experts to join environments with new users to collaboratively work through simulations together.

As another example, a GIS basemap (software agent 105a) with locations of lampposts may be imported into a gaming engine (software agent 105b) where a realistic visualization of the full street is created with full effects (e.g., luminescence change in fog). When the lamppost is selected in a gaming engine display window, the shared model is updated. The GIS viewer (software agent 105n) then reflects the new shared state by displaying full GIS data about the lamppost on the GIS viewer, including IoT (e.g. remaining bulb life, hours of operation, etc.). The shared state is the state of the collaboration between the software agents. In another aspect of this example, software agents may provide instructions for other software agents to carry out as the shared model 109a may include the capacity for discoverable commands. For example, when software agent 105a is aware that an environment is getting dark (e.g. sensors), it can contribute instructions to the shared model 109a for another software agent (e.g., 109b) to send to their systems (e.g. turn on all lampposts in an area).

FIG. 2B shows another example of the environment 100. In the example of FIG. 2B, software agent 105a and software agent 105n have mutually agreed that the shared model 109b is to be used to share data between the two software agents. Software agent 105b is in the agent environment, but not participating. FIG. 2C shows yet another example of the environment 100. In the example of FIG. 2C, software agents 105a, 105b, 105n have mutually agreed to use two shared models (i.e., 109a and 109n) to share differing models of information therebetween. As such, so long as the software agents can mutually agree upon one or more shared models, they will be able to communicate data among each other. Any number of shared models may be used between the agents so long as there is mutual agreement.

With reference to FIG. 2D, there is shown in another implementation within the environment where the software agent 105n is a browser, such as an HTML5 compatible web browser that provides a user interface to view outputs of one or more of the software agents 105a, 105b, 105n. The displayed output of each of the software agents 105a, 105b is presented in a respective display window 104a, 104b (only two are shown, but other numbers may be connected to the collaboration platform 110).

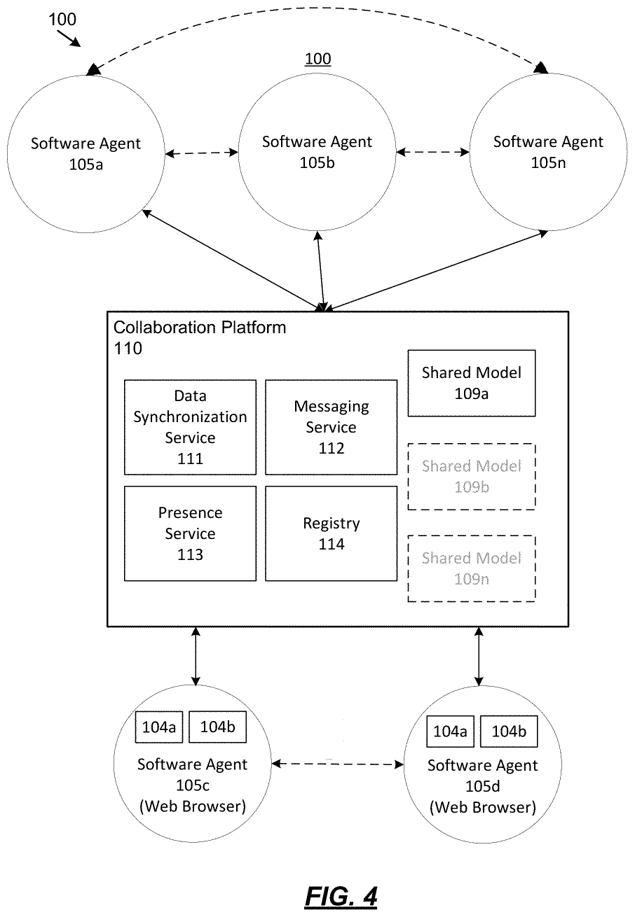

FIG. 4 illustrates another example of another agent environment 100 that includes browsers 105c and 105d as software agents. Both the browsers (i.e., software agents 105c and 105d) provide display windows 104a and 104b associated with software agents 105a and 105b. A user at either of the browsers may interact with one or more of the display windows 104a and 104b to cause an input in the display window to affect the display of the other display window. For example, the users may share audio or video. Each of the browsers displays a synchronized views of the display windows 104a and 104b. The display windows 104a and 104b may be presented side-by-side or layered, as discussed above. Although only two browsers are shown in FIG. 4, additional browsers may be connected to the collaboration platform 110, all showing synchronized views of the display windows 104a and 104b, and having the ability to interact with each other and the software agents 105a and 105b.

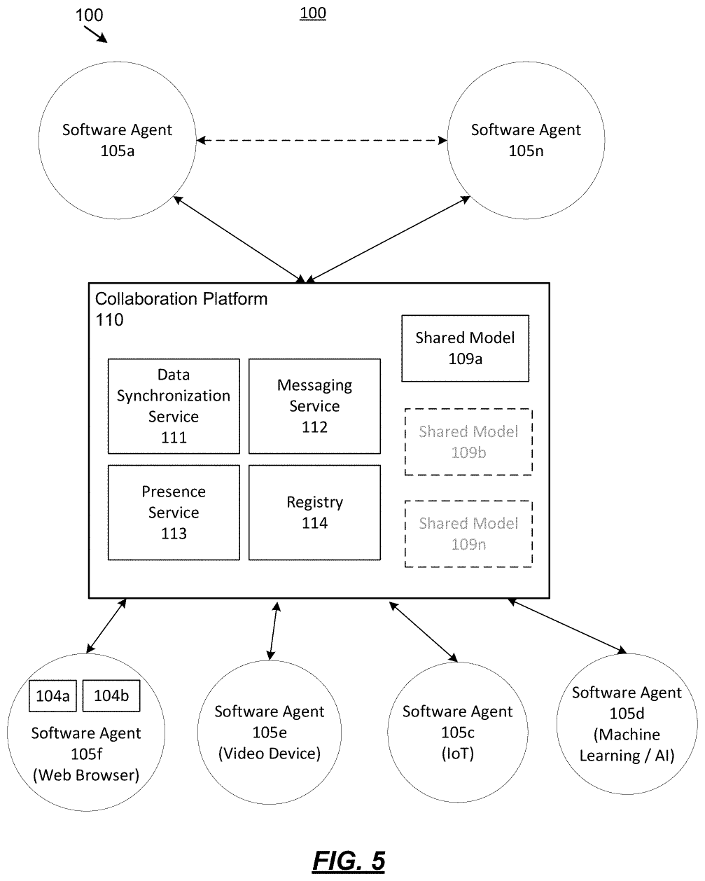

FIG. 5 illustrates another example of the environment 100 that includes one or more Internet of Things (IoT) software agents 105c, a machine learning/artificial intelligence service software agent 105d, and/or a video device software agent 105e connected to the collaboration platform 110 to enable collaboration amongst any of the software agents and the browser (software agent 105f). The machine learning/artificial intelligence service may be queried by other software agents for information, such as analysis of data utilized by the other software agents.

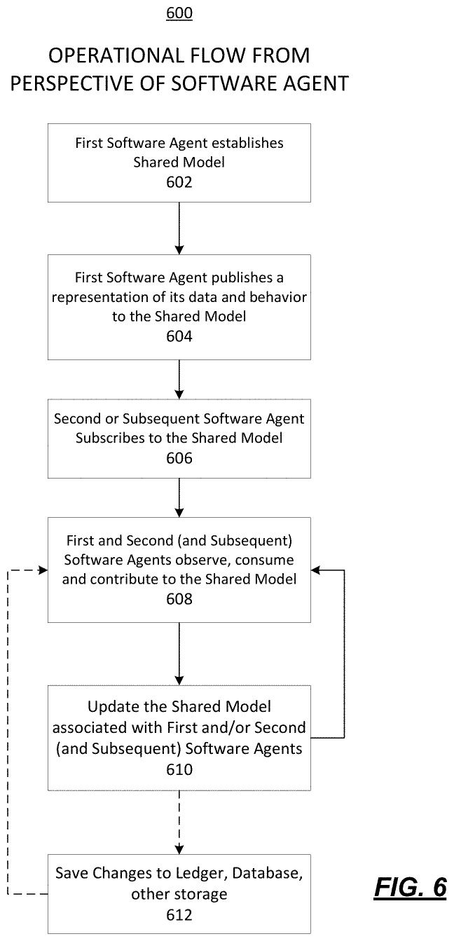

With reference to FIG. 6, there is illustrated an example operational flow 600 of the interaction between a first software agent and a second software agent that are communicatively connected to the collaboration platform 110 using the shared model 109a, 109b and/or 109n. At 602, the first software agent establishes a shared model. For example, software agent 105a may advertise using the registry 114 that it wishes to communicate using shared model 109a. The shared model 109a can be created a number of ways (and in combination). For example, the shared model 109a can be created empty and modified/populated at runtime, refreshed from a long term data source and then modified at runtime, and/or populated from another shared model either in advance, or at runtime.

At 604, the first software agent publishes a representation of its data and behaviors into the shared model 109a for consumption by the second software agent, e.g. software agent 105b. Additional software agents may share data and behaviors using the shared model 109a. By publishing the representation of its data and behaviors into the shared model 109a, this will serve to advertise the shared model 109a to other software agents. Also, the first software may indicate whether data in the shared model 109a will persist after the first agent leaves the agent environment or will be deleted when the first agent leaves the agent environment. This may be indicated by the first software agent to maintain security of the data within the shared model.

At 606, the second software agent 105b subscribes to the shared model 109a. As described above, data is written to the shared model 109a as key/value pairs. A second software agent in the agent environment knows which keys are of interest and will subscribe by registering an interest in those keys. At 408, the first software agent 105a and the second software agent 105b observe, consume and contribute to the shared model 109a. This may be accomplished using the data synchronization service 111. The first software agent 105a and the second software agent 105b observe, consume and contribute to the values associated with the subscribed keys. At 610, the shared model associated with the first software agent and/or the second software agent updated. For example, if the software agent is associated with a web browser, the display window 104a and/or display window 104b is updated. The process may loop back to 609 to allows the software agents to continue to observe, consume and contribute to the shared model. Optionally or additionally, at 612, changes made to the shared model may be stored in a ledger (blockchain), database or other storage (e.g., registry 114). The flow may return to 608 where subsequent updates to the shared model may be made and saved.

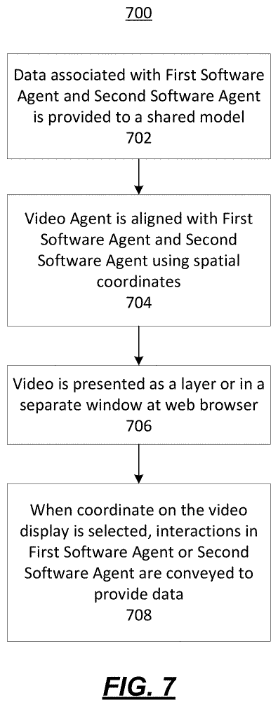

With reference to FIG. 7, there is shown an operational flow 700 that may be implemented in the environment 100 of FIG. 5. At 702, data associated with the first software agent and the second software agent is provided to a shared model. As discussed above, the first software agent (e.g., software agent 105a) and second software agent (e.g., software agent 105b) may agree upon shared model 109a within the collaboration platform 110. At 704, video from the video device (software agent 105e in FIG. 5) is aligned with the first software agent and the second software agent using, e.g. spatial coordinates. Data associated with the spatial coordinates that may be communicated amongst the first software agent and the second software agent and the video device using, e.g., shared model 109a. At 706, video is presented as a layer or in a separate window at the client. At 708, when a coordinate on the video display is selected, commands in the first software agent or second software agent are conveyed to provide updated data. The result may be shown in any of the display windows 104a or 104b. For example, by introducing live video, the CAD and gaming models can also be visually aligned with the actual building, which could be aided by AI using machine vision for object recognition. Once aligned, selecting points on the video view will call to different applications for full data access of the CAD model or GIS. For example, if an object is selected that has accurate measurements in CAD, those measurements can be extended and applied to all objects in the view for improved accuracy.

FIGS. 8A-8C illustrate a context of seismic/GIS data. FIG. 8A illustrates a graphical user interface of an existing seismic application wherein seismic data can be accessed online as an application. FIG. 8B illustrates an existing seismic application with partial GIS information. As shown in FIG. 8B, when GIS data is applied to the seismic data of FIG. 8A, it is presented as a limited, static view. Thus, a limitation of FIGS. 8A-8B is that the GIS data is not imported and/or converted, rather it is presented as a view of the map. However, a geoscientist may want to see where subsurface (i.e. seismic) meets with surface (i.e. GIS) in order to plan where to place the well pad. This cannot be achieved in FIG. 8B. In this situation, it would be useful for a geoscientist to know more GIS details (e.g. soil composition) in the context of the seismic view.

An improvement based on the present disclosure is shown in FIG. 8C, which shows the output where the GIS information and seismic data collaborate together as software agents implementing the operational flow 600 within the collaboration platform 110. With additional reference to FIG. 2D, a side-by-side or layered view is presented in FIG. 8C by software agent 105n (i.e., a web browser) where the GIS and seismic applications communicate as software agents 105a and 105b, respectively, using the shared model to show the full data from each based commands entered into a display window 104a associated with the software agent 105n. For example, selecting a point in the seismic application (e.g., software agent 105b) at the point labeled “Click here” on the left pane will display full data from the GIS mapping application (e.g., software agent 105a) in the right pane.

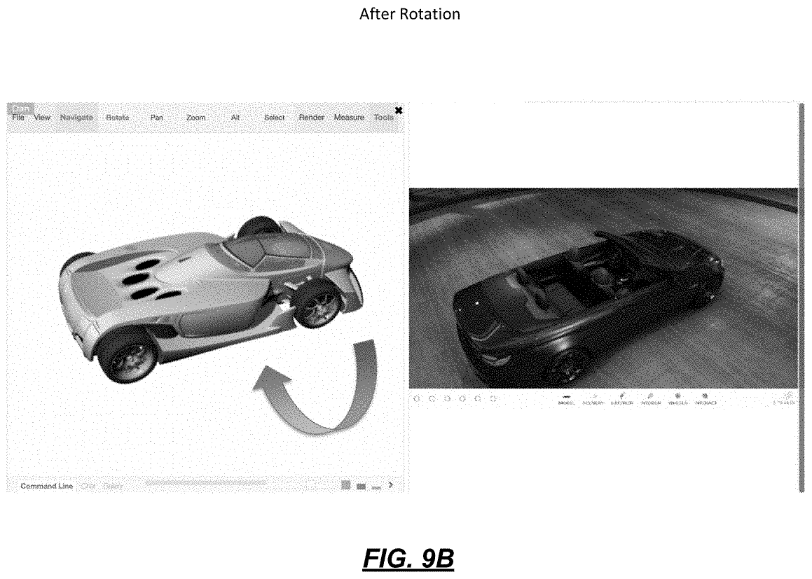

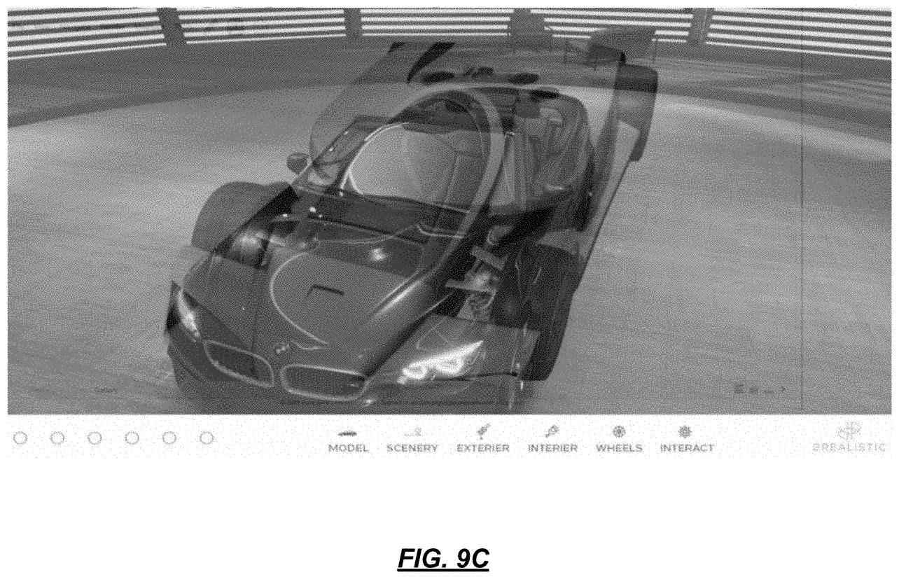

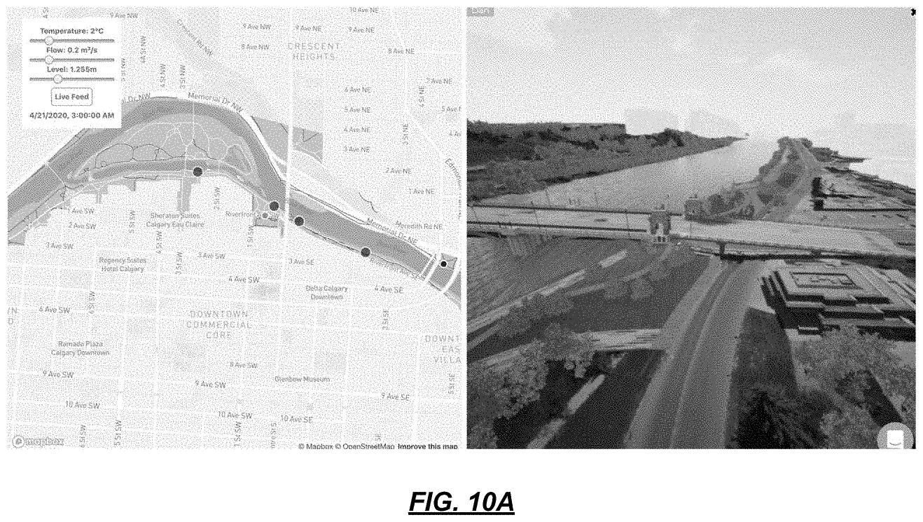

FIGS. 9A-9C illustrate a visual output of the operational flow 600 in the context of a CAD application and a gaming engine. FIG. 9A shows the CAD application and the gaming engine in side-by-side views. A web browser software agent contributes commands ad receives updates. As shown in FIG. 9B, once the applications are aligned, using a shared model, interacting (e.g. rotating) one view in the web browser rotates the other view by posting the rotate command to the shared model. FIG. 9C illustrates an example of the visual display when the CAD application is overlaid on top of the gaming model. The CAD model would be aligned and overlaid of game model. In this example, data points for aligning the models may be based on, e.g., part size.

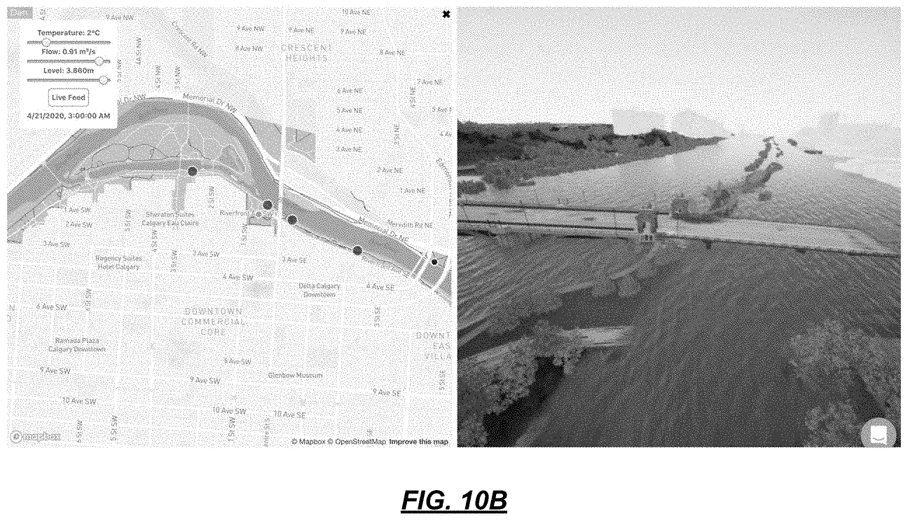

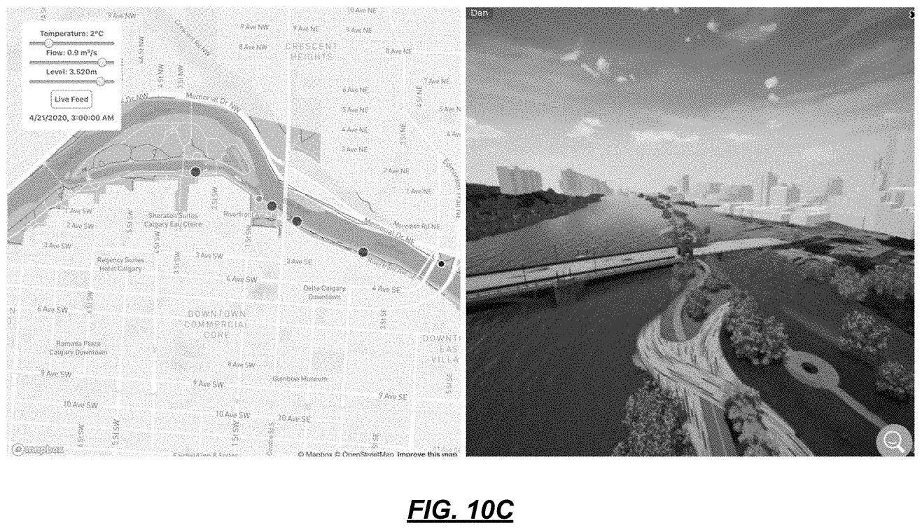

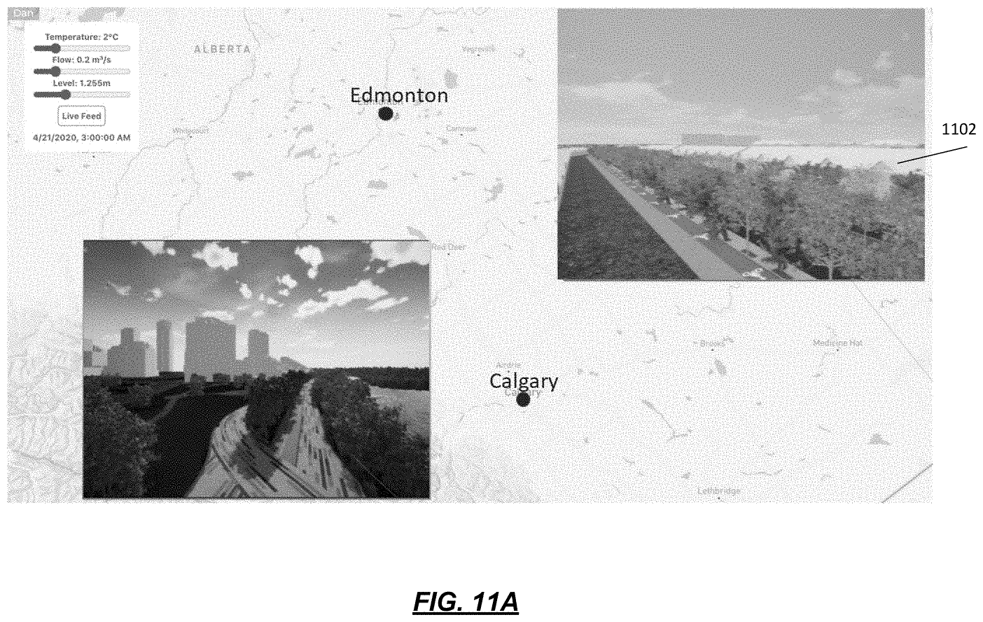

FIGS. 10A-10C illustrate example user interfaces showing a GIS mapping application, a game application and an IoT device collaborating to present an interactive view of a cityscape. In FIGS. 10A-10C, the GIS mapping application, the game application and the IoT device may each be represented as software agents that are all collaborating together in an agent environment. In FIG. 10A the software agents are collaborating to show a map and realistic cityscape in a user interface. A smaller dot on the map shows the position of the vantage point where the user would see the cityscape shown on the right. The larger dots on the map are IOT devices that each measure the height of the water in the river for display in the cityscape visualization. As shown in the top left of the map view, a user is provided certain controls to alter the temperature, a flow rate of the river, and a level of the water in the river.

As shown in FIG. 10B, the user has increased the flow rate and level of the water in order to model, e.g. flooding conditions. As can be seen in the visualization of the cityscape, the water has inundated much of the land areas shown in FIG. 10A. As shown in FIG. 10C, the user may move the vantage point to a different location. Accordingly the visualization of the cityscape changes in real-time with movement of the vantage point to an updated view.

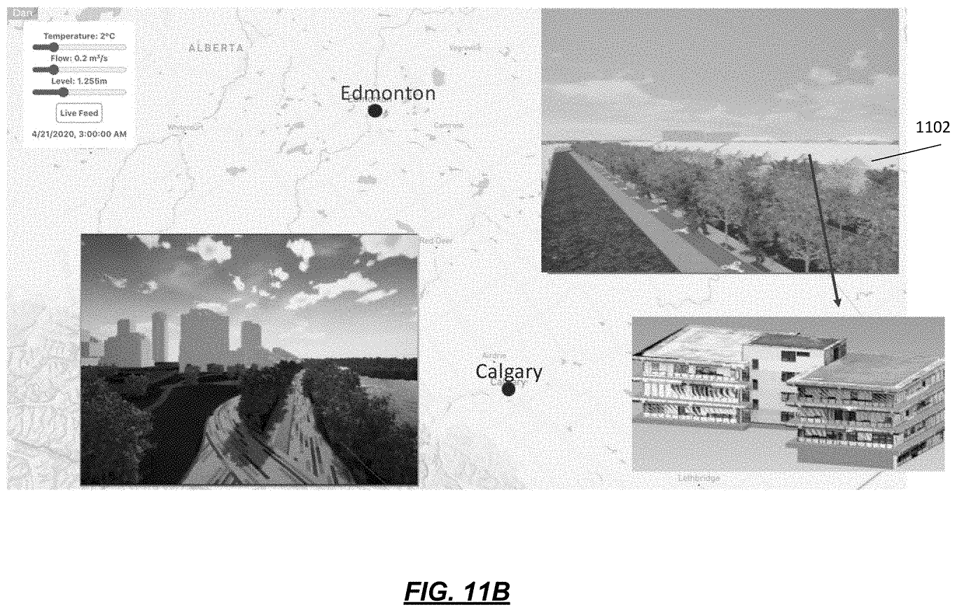

FIGS. 11A-11B illustrate several game agents in combination with other agents to create digital twins. In FIG. 11A, the software agents include a Calgary game model, an Edmonton game model, a GIS map, IoT, and client browser. A user may click on a building 1102 shown in the top right view to display a full CAD model of the building (as shown on the bottom right of FIG. 11B). In FIG. 11B, a CAD model software agent is shown in addition to the other agents in FIG. 11A. FIGS. 11A-11B illustrate an environment having two shared models, where the first is shared between a digital twin that includes the GIS map, the Calgary game model and the IoT, and where the second is shared between a digital twin that includes the GIS map, the Edmonton game model and the CAD model (FIG. 11B). The GIS map joins the two digital twins together to make a digital twin of Alberta. Thus, multiple software agents can be shown together in a single system (e.g. a map) and linked to multiple other systems (e.g. different game models). These can be shown side by side or nested within each other so a simple model can be added to a more complex system. For example, a digital twin of a person (i.e. medical image, watch sensor) can be nested/embedded in the digital twin of an environment (i.e. on a sidewalk).

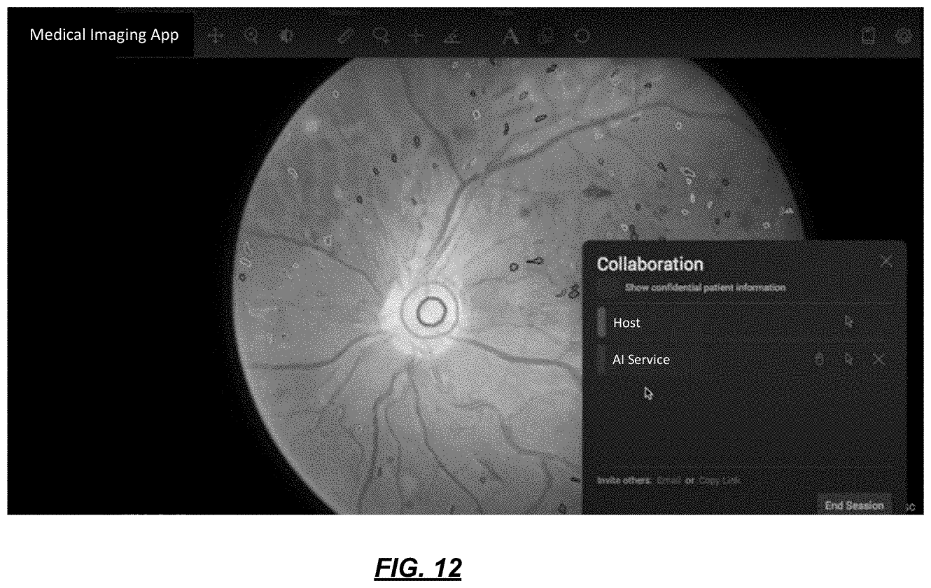

FIG. 12 is an example user interface showing an artificial intelligence service collaborating with a medical imaging application to present an interactive view of medical diagnostic imagery. Three software agents are collaborating in the visualization presented in FIG. 12, i.e., the medical imaging application 105a, a host at a web browser 105b, and an artificial intelligence (AI) service 105c. The AI service may perform analysis of the medical images presented by the medical imaging application, and provide results of the analysis to the host. The example may also exclude the web browser 105b whereby the analysis results are sent to the medical imaging application with no user interaction.

Thus, one of ordinary skill in the art would now understand that many types of applications, services, and devices may collaborate as software agents using the collaboration platform and the features thereof.

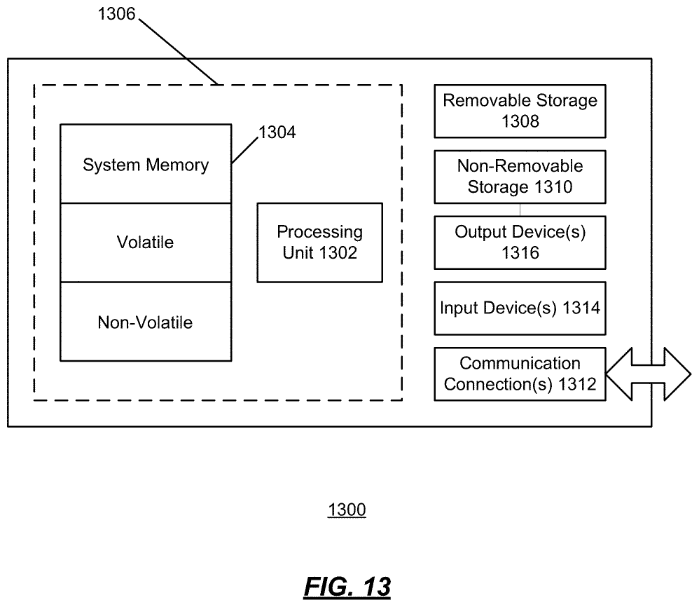

FIG. 13 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 13, an exemplary system for implementing aspects described herein includes a computing device, such as computing device 1300. In its most basic configuration, computing device 1300 typically includes at least one processing unit 1302 and memory 1304. Depending on the exact configuration and type of computing device, memory 1304 may be volatile (such as random access memory (RAM)), non-volatile (such as read-only memory (ROM), flash memory, etc.), or some combination of the two. This most basic configuration is illustrated in FIG. 13 by dashed line 1306.

Computing device 1300 may have additional features/functionality. For example, computing device 1300 may include additional storage (removable and/or non-removable) including, but not limited to, magnetic or optical disks or tape. Such additional storage is illustrated in FIG. 13 by removable storage 1308 and non-removable storage 1310.

Computing device 1300 typically includes a variety of tangible computer readable media. Computer readable media can be any available tangible media that can be accessed by device 1300 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 1304, removable storage 1308, and non-removable storage 1310 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1300. Any such computer storage media may be part of computing device 1300.

Computing device 1300 may contain communications connection(s) 1312 that allow the device to communicate with other devices. Computing device 1300 may also have input device(s) 1314 such as a keyboard, mouse, pen, voice input device, touch input device, etc. Output device(s) 1316 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A collaboration platform for providing a shared software agent environment between at least two heterogenous software agents, comprising:
a data synchronization service into which a first software agent publishes properties and behaviors into a shared model,
wherein the data synchronization service advertises the shared model such that at least one second software agent subscribes to properties and behaviors that are of interest to the least one second software agent,
wherein the first software agent and/or the at least one second software agent utilize a communication link between each of the first software agent and the at least one second software agent to observe, consume and/or contribute to the shared model, and
wherein updated data from the shared model is synchronized between the first software agent and the at least one the second software agent in the shared software agent environment.

2. The collaboration platform of claim 1, wherein the properties and behaviors are identified by key/value pairs, and wherein properties the and behaviors that are of interest to the least one second software agent are identified by a unique key associated with each property and behavior.

3. The collaboration platform of claim 2, wherein an updated to a particular key/value pair causes the data synchronization service to notify the least one second software agent of the updated using a publish-subscribe-based messaging protocol.

4. The collaboration platform of claim 1, wherein the shared model is an abstraction that represents common properties and behaviors modeled by the first software agent and the at least one second software agent.

5. The collaboration platform of claim 1, further comprising a messaging service that provides communications between the first software agent and/or the at least one second software agent using a publish-subscribe-based messaging protocol.

6. The collaboration platform of claim 1, further comprising a presence service that sends notifications as the first software agent and/or the at least one second software arrive and leave the shared software agent environment.

7. The collaboration platform of claim 1, wherein an audit trail of the interactions of the first software agent and the at least one second software agent with the shared model are stored in a registry.

8. The collaboration platform of claim 7, further comprising bookmarking a state of shared agent environment from information in the registry.

9. The collaboration platform of claim 7, further comprising capturing the interactions in a blockchain.

10. The collaboration platform of claim 1, wherein the first software agent and the at least one second software comprise one of a web browser, a mapping application, a seismic application, a game engine, Building Information Modeling (BIM) application, a computer aided design (CAD) application, a medical imaging application, an Internet of Things (IoT) device, an artificial intelligence (AI) service, a WebRTC application, and a legacy software application.

11. The collaboration platform of claim 10, wherein data associated with the first software agent is visually aligned with data associated with the at least one second software agent.

12. The collaboration platform of claim 1, wherein the communication link is a peer-to-peer connection between first software agent and the at least one second software agent.

13. The collaboration platform of claim 12, wherein the peer-to-peer connection is used by the first software agent and the at least one second software agent to provide a private communication link therebetween.

14. The collaboration platform of claim 1, wherein a view is presented that is associated with the first software agent and/or the at least one second software agent and the shared model.

15. The collaboration platform of claim 1, wherein the first software agent and the at least one second software agent combine to create a digital twin.

16. A framework for creating a shared agent environment between at least two heterogenous software agents, comprising:
a collaboration platform that includes a data synchronization service that provides a mechanism wherein the software agents publish and subscribe to messages, and wherein software agents advertise a shared model that is used to exchange information and behaviors in collaboration between the software agents in the shared agent environment,
wherein the collaboration platform receives a connection from a first software agent and at least one second software agent,
wherein the first software agent publishes a representation of the data and behaviors into the shared model for consumption and thereafter advertises the shared model using the data synchronization service;
wherein the at least one second software agent subscribes to the shared model;
wherein the first software agent and/or the at least one second software agent use a communication link between each of the first software agent and the at least one second software agent and use the data synchronization service to observe, consume and/or contribute to the shared model, and
wherein a view is presented that is associated with the first software agent and/or the at least one second software agent and the shared model.

17. The framework of claim 16, wherein the data synchronization service communicates using a publish-subscribe-based messaging protocol.

18. The framework of claim 16, further comprising a presence service that determines a presence of the first software agent and the at least one second software agent.

19. The framework of claim 16, wherein the shared model is an abstraction that represents common properties and behaviors modeled by the first software agent and the at least one second software agent.

20. The framework of claim 16, wherein one of the first software agent or the at least one second software agent a publishes change to a property or behavior represented in the shared model using the data synchronization service, and wherein the other of the first software agent or the at least one second software agent receives a notification from the data synchronization service of the change to the property or behavior represented in the shared model to update the state of the shared agent environment.

21. The framework of claim 16, further comprising a registry that maintains an audit trail of the interactions of the first software agent and the at least one second software agent by storing information from the shared model.

22. The framework of claim 21, further comprising bookmarking a state of shared agent environment from the information in the registry.

23. The framework of claim 21, further comprising capturing the information in a blockchain.

24. The framework of claim 16, wherein the first software agent and the at least one second software comprise one of a web browser, a mapping application, a seismic application, a game engine, Building Information Modeling (BIM) application, a computer aided design (CAD) application, a medical imaging application, an Internet of Things (IoT) device, an artificial intelligence (AI) service, a WebRTC application, and a legacy software application.

25. The framework of claim 23, wherein data associated with the first software agent is visually aligned with data associated with the at least one second software agent.

26. A method for a shared agent environment between at least two heterogenous software agents, comprising:
receiving a connection at a collaboration platform from a first software agent and at least one second software agent;
establishing, by a first software agent, a shared model to share a common representation of data and behaviors with at least one second software agent;
publishing and advertising, by the first software agent using a data synchronization service, a representation of the data and behaviors into the shared model for consumption;
subscribing, by the at least one second software agent, to the shared model;
establishing a communication connection between each of the first software agent and the at least one second software agent;
observing, consuming and/or contributing to the shared model using the data synchronization service by the first software agent and/or the at least one second software agent; and
presenting in response to the observing, consuming and/or contributing, updated data in a view associated with the first software agent and/or the at least one second software agent.
